(19) United States
(12) Patent Application Publication
(10) Pub. No.: US 2020/0387468 A1
(43) Pub. Date: Dec. 10, 2020

(54) Information Processing System And Computer-Readable Recording Medium Storing Program

(71) Applicant: FUJITSU CLIENT COMPUTING LIMITED, Kawasaki-shi (JP)

(72) Inventors: Masatoshi KIMURA, Kawasaki (JP); Tomohiro ISHIDA, Kawasaki (JP)

(21) Appl. No.: 16/861,251

(22) Filed: Apr. 29, 2020

(30) Foreign Application Priority Data
Jun. 5, 2019 (JP) 2019-104982

(51) Int. Cl. G06F 13/40

(52) U.S. Cl. CPC G06F 13/4045; G06F 2213/0026; G06F 13/4031; G06F 13/4009

(57) ABSTRACT

An information processing system includes an information processing device, a computational processing device group, and a relay device. The information processing device corresponds to a host in the system. The computational processing device group includes a plurality of computational processing devices and corresponds to input/output (I/O) devices. The relay device has an expansion bus to which the information processing device and the computational processing device group are capable of connecting. The information processing device transmits data via the relay device to the computational processing device group. The computational processing device group executes distributed processing between the computational processing devices based on the data and transmits an execution result via the relay device to the information processing device.

### CROSS-REFERENCE TO RELATED APPLICATION

This application is based upon and claims the benefit of priority of the prior Japanese Patent Application No. 2019-104982, filed on Jun. 5, 2019, the entire contents of which are incorporated herein by reference.

### FIELD

The embodiments discussed herein are related to an information processing system and a computer-readable recording medium storing program.

### BACKGROUND

In recent years, it has become possible to execute high computational loads, such an AI (Artificial Intelligence) inference processing and image processing, on a personal computer (PC) or the like. High computational performance has also been achieved by equipping PCs with computational processors called GPUs (Graphics Processing Units) and FPGAs (Field Programmable Gate Arrays).

PCI Express (Peripheral Component Interconnect Express: Registered Trademark), which has a large data bandwidth, is used as the interface for interconnecting these computational processors.

In a system equipped with a PCI Express interface, a computational processor that acts as a host at the PC functions as the “Root Complex (RC)” for PCI Express.

A computational processor at an input/output (I/O) device that communicates with the PC functions as an “End Point (EP)” for PCI Express. The root complex is connected to an end point and data for AI inference processing or image processing is transferred between the host and the device.

As an example of a related art, there has been proposed a technology that is equipped with a plurality of connectors that enable a host and cards to be connected to PCI Express, connects the connectors of the respective cards, and transfers data between the cards.

See, for example, Japanese Laid-open Patent Publication No. 2017-134475.

In a system where a plurality of devices are connected to a host via PCI Express, instructions and data are conventionally transferred between the host and devices, but there is no transferring of instructions and data between the devices themselves.

For this reason, when data is transferred between devices, such as when handing data over from the computational processor of one device to the computational processor of another device, there has been the problem of this data transfer involving the processor of the host, which increases the processing load of the host.

### SUMMARY

According to an aspect, there is provided an information processing system including: a relay device that includes an expansion bus and relays communication via the expansion bus; a computational processing device group that includes a plurality of computational processing devices individually connected to the expansion bus and performs distributed processing for computation on data inputted into any one of the plurality of computational processing devices through communication between the plurality of computational processing devices via the relay device; and an information processing device that is connected to the expansion bus and acquires an execution result of the distributed processing from the computational processing device group via the relay device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 depicts one example of an information processing system;

FIG. 2 depicts one example configuration of a platform equipped with PCIe;

FIG. 3 depicts one example configuration of an information processing system;

FIG. 4 depicts an example application of an information processing system to edge computing;

FIG. 5 depicts an example hardware configuration of the information processing system;

FIG. 6 depicts an example hardware configuration of a PCIe bridge controller;

FIG. 7 depicts an example of data transfers between coprocessors;

FIG. 8 depicts one example of data transfers between coprocessors;

FIG. 9 depicts one example of distributed processing;

FIG. 10 depicts another example of distributed processing;

FIG. 11 depicts another example of distributed processing;

FIG. 12 depicts another example of distributed processing;

FIG. 13 depicts one example of a definition file;

FIG. 14 is a flowchart depicting an example of a setting operation by a main processor; and

FIG. 15 is a flowchart depicting an example operation of distributed processing by coprocessors.

### DESCRIPTION OF EMBODIMENTS

Several embodiments will be described below with reference to the accompanying drawings.

### First Embodiment

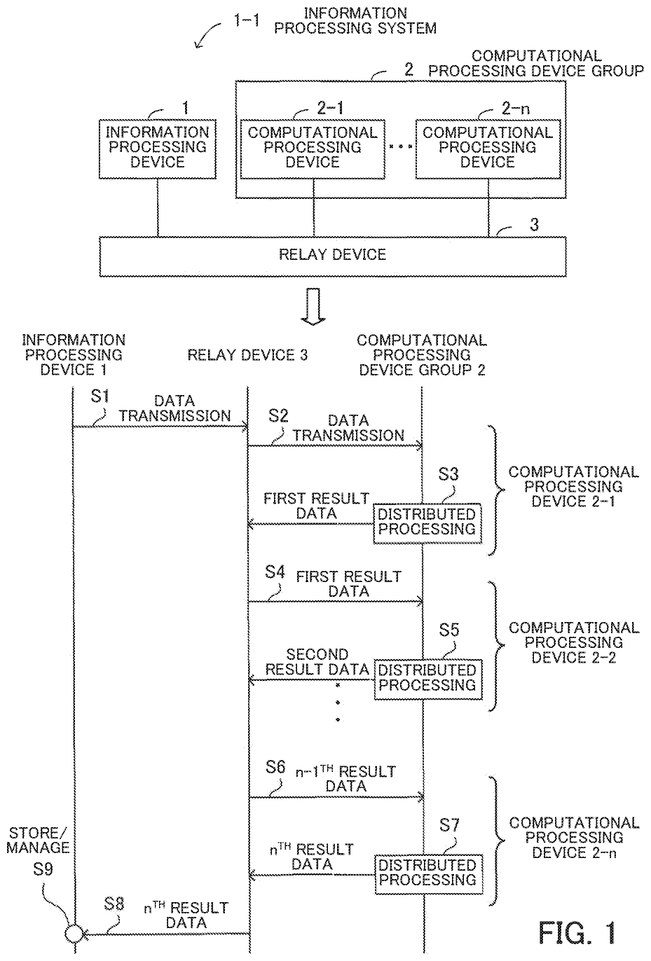

FIG. 1 depicts one example of an information processing system. The information processing system 1-1 includes an information processing device 1, a computational processing device group 2, and a relay device 3. The information processing device 1 corresponds to the host in the system. The computational processing device group 2 includes a plurality of computational processing devices 2-1, . . . , 2-n, which correspond to I/O devices. The relay device includes an expansion bus to which the information processing device 1 and the computational processing device group 2 are connected. The expansion bus may be an expansion bus for peripheral devices.

The relay device 3 relays communication via the expansion bus. The computational processing device group 2 includes the plurality of computational processing devices 2-1, . . . , 2-n that are respectively connected to the expansion bus. By having the plurality of computational processing devices 2-1, . . . , 2-n communicate via the relay device 3, the computational processing device group 2 performs computation on data inputted into any of the computational processing devices 2-1, . . . , 2-n through distributed processing. The information processing device 1 is connected to the expansion bus and acquires the execution result of the distributed processing from the computational processing device group 2 via the relay device 3.

An example operation will now be described based on the sequence depicted in FIG. 1.

(Step S1) The information processing device 1 transmits data to the relay device 3.

(Step S2) The relay device 3 relays the data to the computational processing device 2-1.

(Step S3) The computational processing device 2-1 executes distributed processing based on the data and transmits first result data, which is the result of the distributed processing, to the relay device 3.

(Step S4) The relay device 3 relays the first result data to the computational processing device 2-2.

(Step S5) The computational processing device 2-2 executes distributed processing based on the first result data and transmits second result data, which is the result of the distributed processing, to the relay device 3. Following this, distributed processing is performed in the same way by the computational processing device 2-3 to the computational processing device 2-(n−1).

(Step S6) The relay device 3 relays the (n−1)^{th} result data transmitted from the computational processing device 2-(n−1) to the computational processing device 2-n.

(Step S7) The computational processing device 2-n executes distributed processing based on the (n−1)^{th} result data and transmits n^{th} result data, which is the result of the distributed processing, to the relay device 3.

(Step S8) The relay device 3 relays the n^{th} result data to the information processing device 1.

(Step S9) The information processing device 1 stores and manages (including processing for data analysis) the n^{th} result data.

In this way, in the information processing system 1-1, distributed processing is executed on the data transmitted from the information processing device 1 via the relay device 3 by the computational processing devices 2-1, . . . , 2-n and an execution result is transmitted via the relay device 3 to the information processing device 1.

By using this configuration, when data is transferred between the computational processing devices, such as when data is handed over from one computational processing device to another computational processing device, the information processing device that acts as the host does not need to be involved. This means that it is possible to transfer instructions and data between the computational processing devices and to reduce the processing load at the host.

### Second Embodiment

A second embodiment will now be described. The information processing system according to the second embodiment transfers data using a PCI Express (hereinafter indicated as “PCIe”) interface. First, the configuration and problems with a conventional platform will be described.

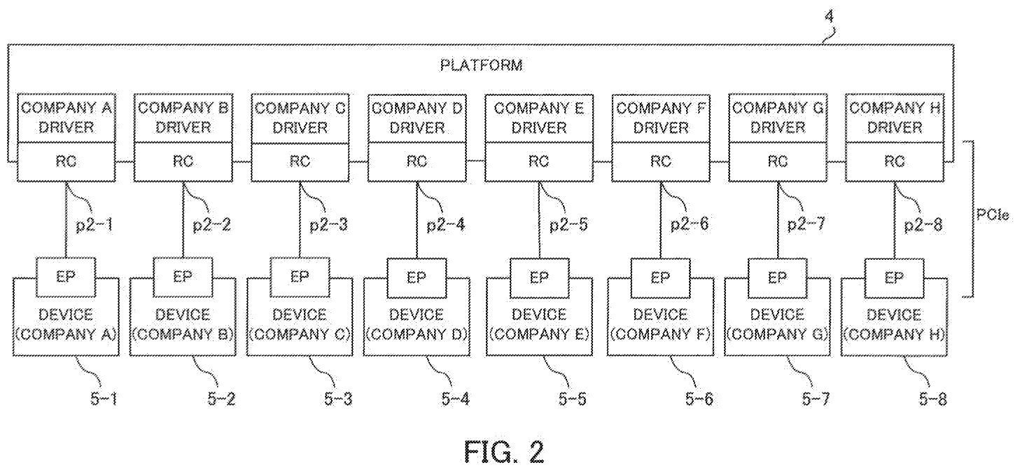

FIG. 2 depicts one example configuration of a platform equipped with PCIe. A PCIe-equipped platform 4 is a root complex (hereinafter indicated as “RC”) and devices 5-1, . . . , 5-8 are end points (hereinafter indicated as “EP”), with the devices 5-1, . . . , 5-8 being connected to the platform 4.

That is, the platform 4 is equipped with RC ports p2-1, . . . , p2-8 to which EP are connected, and devices 5-1, . . . , 5-8 are connected on a one-to-one basis via PCIe interfaces to the ports p2-1, . . . , p2-8.

As one example, an Intel x86-compatible processor is provided in the platform 4 and runs a general purpose OS (Operating System). Controllers used in the devices 5-1, . . . , 5-8 are separately provided by the respective manufacturers (Company A to Company H).

To drive the devices 5-1, . . . , 5-8, it is possible to use the devices 5-1, . . . , 5-8 by installing drivers corresponding to the devices 5-1, . . . , 5-8 onto the OS of the platform 4.

This means that it is not possible to independently drive the devices 5-1, . . . , 5-8, and when the platform 4 malfunctions, all of the devices 5-1, . . . , 5-8 stop functioning.

Since the drivers provided in the platform 4 are developed together with the hardware and/or OS of the platform 4, when the OS of the platform 4 changes, further development of the drivers is performed as appropriate.

In addition, with this configuration, when data transfer is performed between devices, for example, when data is handed over from one device to another device, the transferring will be performed via the platform 4 as the host, which increases the processing load at the host.

The present embodiments were conceived in view of this issue and make it possible to independently drive devices, avoid the need for developing drivers on a device basis, and transfer data with a reduced processing load at the host.

System Configuration

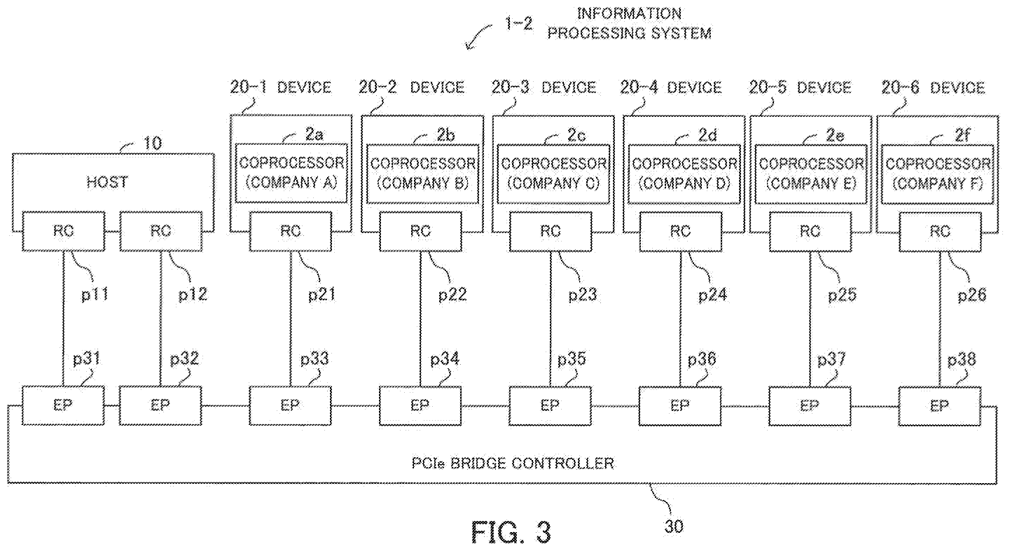

The configuration and operation of the second embodiment will now be described in detail. FIG. 3 depicts one example configuration of an information processing system. The information processing system 1-2 includes a host 10, devices 20-1, . . . , 20-6, and a PCIe bridge controller 30.

The host 10 has the functions of the information processing device 1 in FIG. 1, and the devices 20-1, . . . , 20-6 have the functions of the computational processing devices 2-1, . . . , 2-n in FIG. 1. The PCIe bridge controller 30 has the functions of the relay device 3 in FIG. 1.

In FIG. 3, the host 10 corresponds to a platform and functions as the RC. The devices 20-1, . . . , 20-6 function as RCs. The PCIe bridge controller 30 functions as an EP (end point). Note that the devices 20-1, . . . , 20-6 are respectively equipped with coprocessors 2a, . . . , 2f produced by the respective manufacturers, Company A to Company F.

The host 10 includes RC ports p11 and p12 and the devices 20-1, . . . , 20-6 include RC ports p21, . . . , p26. The PCIe bridge controller 30 includes EP ports p31, . . . , p38. Note that the host 10 may only have one of the ports p11 and p12. Further, RC ports p11 and p12 may be used independently, and RC port p12 may be assigned as a device, for example.

The connections between the component elements will now be described. The host 10 is connected to the PCIe bridge controller 30 with the RC port p11 connected to the EP port p31 and the RC port p12 connected to the EP port p32.

The device 20-1 and the PCIe bridge controller 30 are connected with the RC port p21 connected to the EP port p33. The device 20-2 and the PCIe bridge controller 30 are connected with the RC port p22 connected to the EP port p34. The device 20-3 and the PCIe bridge controller 30 are connected with the RC port p23 connected to the EP port p35.

In addition, the device 20-4 and the PCIe bridge controller 30 are connected with the RC port p24 connected to the EP port p36. The device 20-5 and the PCIe bridge controller 30 are connected with the RC port p25 connected to the EP port p37. The device 20-6 and the PCIe bridge controller 30 are connected with the RC port p26 connected to the EP port p38.

In the information processing system 1-2, arbitrary OSs run on the coprocessors 2a, . . . , 2f, and there are no limitations on interconnects to the platform and the like. Further, any RC appliances may be connected to the EP ports p31, . . . , p38 of the PCIe bridge controller 30.

In addition, even when different OSs are running on the independent coprocessors 2a, . . . , 2f, data is transferred between the coprocessors by using the PCIe bridge controller drivers of the respective OSs.

In addition, in the information processing system 1-2, by connecting the PCIe bridge controller 30 as an EP to each coprocessor, it becomes possible for data that has been processed by one of the coprocessors to be processed by another coprocessor, without developing the driver of each connected RC appliance.

Application to Edge Computing

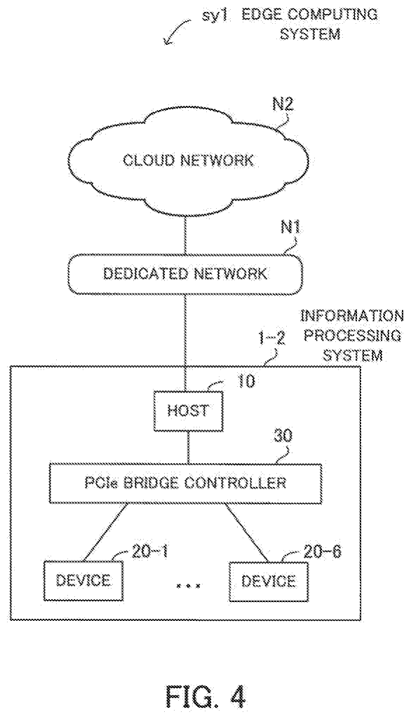

FIG. 4 depicts an example application of an information processing system to edge computing. It is possible to apply the information processing system 1-2 to edge computing with the host 10 described above with reference to FIG. 3 as a network interface.

An edge computing system sy1 includes the information processing system 1-2, a dedicated network N1 (such as the Internet), and a cloud network N2. The host 10 in the information processing system 1-2 is connected to the dedicated network N1, and the dedicated network N1 is connected to the cloud network N2.

The host 10 collects data processed by the devices 20-1, . . . , 20-6 that have an RC function, and transmits the data to the cloud network N2 via the dedicated network N1.

With this configuration, it is possible to perform processing at the edge and save resources on the cloud. Doing so eliminates the response time for communication via the cloud network N2 and ensures real-time performance.

Since data is processed at the host 10 (that is, the edge) and the result is transmitted to the cloud network N2, the confidentiality of data is ensured. In addition, by processing data at the host 10 and transmitting only the necessary data to the cloud network N2, the amount of communication may be reduced.

Hardware

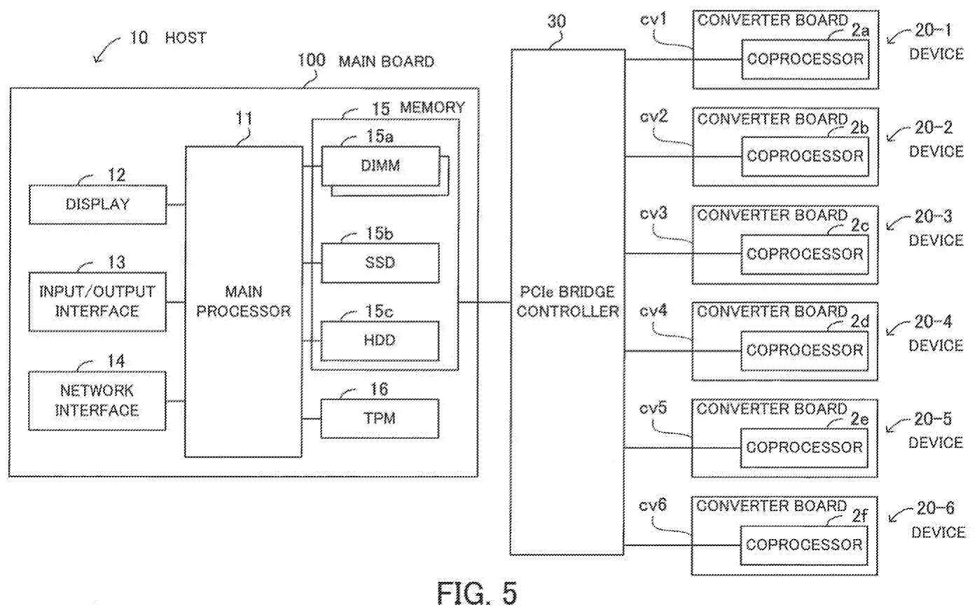

FIG. 5 depicts an example hardware configuration of the information processing system. A main board 100 is a board on which components for performing the main functions of the host 10 are mounted. The host 10 includes a main processor 11, a display 12, an input/output interface 13, a network interface 14, a memory 15, and a TPM (Trusted Platform Module) 16.

The memory 15 includes a DIMM (Dual Inline Memory Module) 15a, an SSD (Solid State Drive) 15b, and an HDD (Hard Disk Drive) 15c.

The main processor 11 is a processor that handles the main functions of the host 10, and may be a multiprocessor. As examples, the main processor 11 is a central processing unit (CPU), a micro processing unit (MPU), a digital signal processor (DSP), an application specific integrated circuit (ASIC), or a programmable logic device (PLD). The main processor 11 may also be a combination of two or more out of a CPU, an MPU, a DSP, an ASIC, and a PLD.

The display 12 functions as a display unit that displays various information, and as one example is a monitor (such as an LED (Light Emitting Diode) or an LCD (Liquid Crystal Display)).

The input/output interface 13 functions as a communication interface for connecting peripherals. As one example, the input/output interface 13 is capable of connecting to USB (Universal Serial Bus) devices and handles communication between USB devices and the main processor 11.

As one example, the input/output interface 13 may be connected to an optical drive device that reads data recorded on an optical disc using a laser beam or the like. Optical discs include a Blu-ray disc (registered trademark), a CD-ROM (Compact Disc Read Only Memory), and a CD-R (Recordable)/RW (Rewritable).

In addition, the input/output interface 13 may connect a memory device or a memory reader/writer. The memory device is a recording medium with a communication function for communicating with the input/output interface 13. A memory reader/writer is a device that writes data onto a memory card or reads data from a memory card. A memory card is a card-type recording medium.

The network interface 14 connects to a network line and handles communication between external appliances and the main processor 11 via the network line. As one example, the network is an Ethernet (registered trademark). As examples of the network interface 14, an NIC (Network Interface Card) or a wireless LAN (Local Area Network) card may be used.

The memory 15 stores an OS program, application programs, and various data. The DIMM 15a is a volatile recording medium, such as RAM (Random Access Memory) capable of temporarily storing various information. The SSD 15b and the HDD 15c are non-volatile recording media capable of storing various types of information even after the power is turned off. The TPM 16 is a module that realizes a security function for the system.

The PCIe bridge controller 30 acts as a bridge connecting between a plurality of devices 20-1, . . . , 20-6 and relays communication between the host 10 and the devices 20-1, . . . , 20-6 and communication between the devices 20-1, . . . , 20-6 themselves.

The devices 20-1, . . . , 20-6 are connected to the PCIe bridge controller 30 in parallel. The devices 20-1, . . . , 20-6 include converter boards cv1, . . . , cv6 and coprocessors 2a, . . . , 2f.

The converter boards cv1, . . . , cv6 are also called “accelerator boards” and are boards on which additional hardware used to increase the processing performance of the information processing system 1-2 is mounted.

The coprocessors 2a, . . . , 2f are processors suited to parallel computational processing such as AI inference processing and image processing, and may use an accelerator such as a GPU or a dedicated chip. The coprocessors 2a, . . . , 2f may each be a combination of a CPU and a GPU. Although not illustrated, a memory is mounted in each of the devices 20-1, . . . , 20-6.

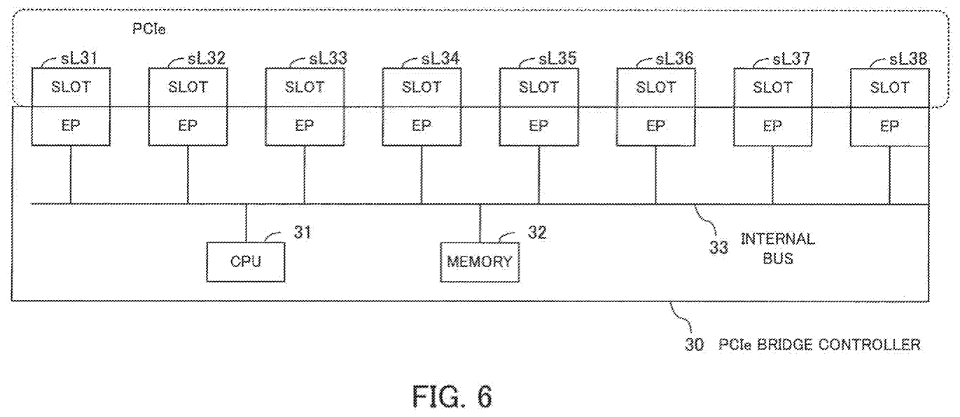

FIG. 6 depicts an example hardware configuration of the PCIe bridge controller. As one example, the PCIe bridge controller 30 is a relay device with an 8-channel EP in a single chip. The PCIe bridge controller 30 includes a CPU 31, a memory 32, an internal bus 33, and a plurality of slots sL31, . . . , sL38 (which correspond to EP ports).

A device or host configured to satisfy PCIe standard is connected to each of the slots sL31, . . . , sL38. Note that various modifications may be made to the connection arrangement, such as having one processor connected to one slot, or connecting one host or device to one slot.

The slots sL31, . . . , sL38 are connected to each other via the internal bus 33. The CPU 31 and the memory 32 are also connected to the internal bus 33. By doing so, it becomes possible for the hosts or devices connected to the slots sL31, . . . , sL38 to communicate with the CPU 31 and the memory 32 via the internal bus 33.

As one example, the memory 32 is a storage memory including a ROM and a RAM. Software programs related to data communication control and various data of the programs are written in the ROM of the memory 32. The software programs in the memory 32 are read out and executed as appropriate by the CPU 31. The RAM of the memory 32 is used as a primary storage memory and a working memory.

The CPU 31 controls the entire PCIe bridge controller 30. The CPU 31 may be a multiprocessor. Note that any one of an MPU, a DSP, an ASIC, a PLD, and an FPGA may be used in place of the CPU 31. Data transfer by the PCIe bridge controller 30 is realized by the CPU 31 executing a software program stored in the memory 32.

The PCIe bridge controller 30 uses PCIe to speed up data transfers between devices, and enables the processors provided at a host and devices to operate as RCs to realize data transfers between EPs.

A variety of known methods may be used as a method for connecting the PCIe bridge controller 30 as an EP to a processor. As one example, when the PCIe bridge controller 30 connects to a host or a device, the PCIe bridge controller 30 provides the processor in the host or device with a signal indicating that the PCIe bridge controller 30 is functioning as an EP and thereby connects to the processor as an EP. As one example, the PCIe bridge controller 30 transfers the data to a plurality of RCs by tunneling the data according to EPtoEP (End Point to End Point).

Example of Data Transfers Between Coprocessors

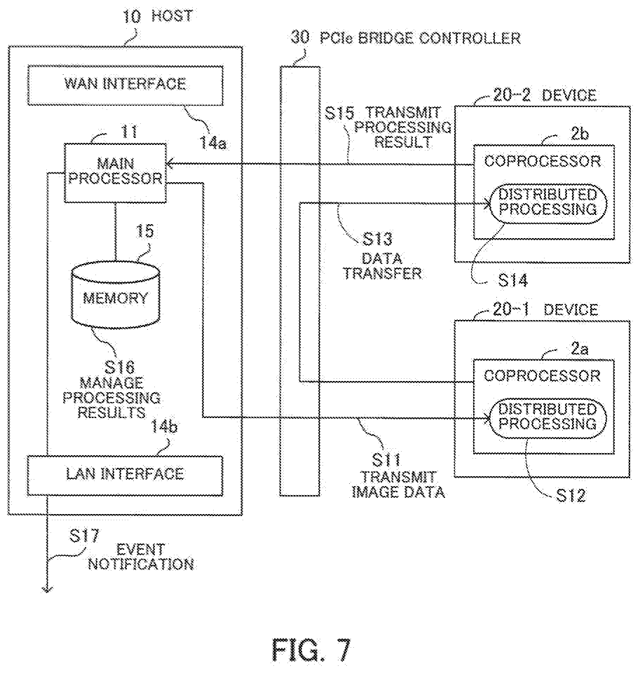

FIG. 7 depicts an example of data transfers between coprocessors. In the drawing, the host 10 includes a WAN (Wide Area Network) interface 14a and a LAN interface 14b as the network interface 14.

(Step S11) The main processor 11 in the host 10 transmits image data via the PCIe bridge controller 30 to the coprocessor 2a in the device 20-1.

(Step S12) The coprocessor 2a performs predetermined distributed processing on the received image data.

(Step S13) The coprocessor 2a transmits the result of the distributed processing via the PCIe bridge controller 30 to the coprocessor 2b in the device 20-2.

(Step S14) The coprocessor 2a continues the predetermined distributed processing on the received result of the distributed processing.

(Step S15) The coprocessor 2b transmits the result of the distributed processing via the PCIe bridge controller 30 to the main processor 11.

(Step S16) The main processor 11 stores and manages the processing result in the memory 15.

(Step S17) The main processor 11 provides an event notification based on the processing result via the LAN interface 14b. As one example, when a suspicious person has been detected from an image processing result, an alert notification is given.

As described above, by executing distributed processing by performing data transfers between the coprocessors via the PCIe bridge controller 30 without passing the main processor 11 and then transmitting the execution result to the main processor 11, the processing load of the main processor 11 is reduced.

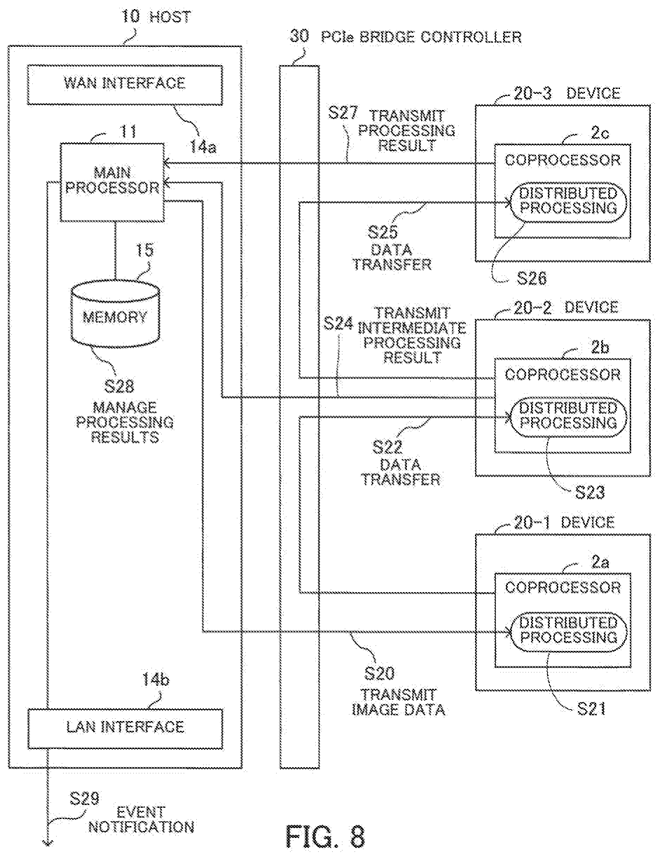

FIG. 8 depicts one example of data transfers between coprocessors.

(Step S20) The main processor 11 in the host 10 transmits image data via the PCIe bridge controller 30 to the coprocessor 2a in the device 20-1.

(Step S21) The coprocessor 2a performs predetermined distributed processing on the received image data.

(Step S22) The coprocessor 2a transmits the result of the distributed processing via the PCIe bridge controller 30 to the coprocessor 2b in the device 20-2.

(Step S23) The coprocessor 2b continues the predetermined distributed processing on the received distributed processing result.

(Step S24) The coprocessor 2b also transmits an intermediate processing result of the distributed processing to the main processor 11 via the PCIe bridge controller 30.

(Step S25) The coprocessor 2b transmits the result of the distributed processing via the PCIe bridge controller 30 to the coprocessor 2c in the device 20-3.

(Step S26) The coprocessor 2c continues the predetermined distributed processing on the received result of the distributed processing.

(Step S27) The coprocessor 2c transmits the result of the distributed processing via the PCIe bridge controller 30 to the main processor 11.

(Step S28) The main processor 11 stores and manages the processing result in the memory 15.

(Step S29) The main processor 11 provides an event notification based on the processing result via the LAN interface 14b.

As described above, in the example in FIG. 8, an intermediate processing result of the distributed processing is transmitted from the coprocessor 2b to the main processor 11. By doing so, it becomes possible for the main processor 11 to recognize a result intermediate in the distributed processing at an earlier stage, which makes it possible to execute event detection and the notification process that follows event detection earlier without waiting for the final result of the distributed processing.

Various Patterns of Distributed Processing

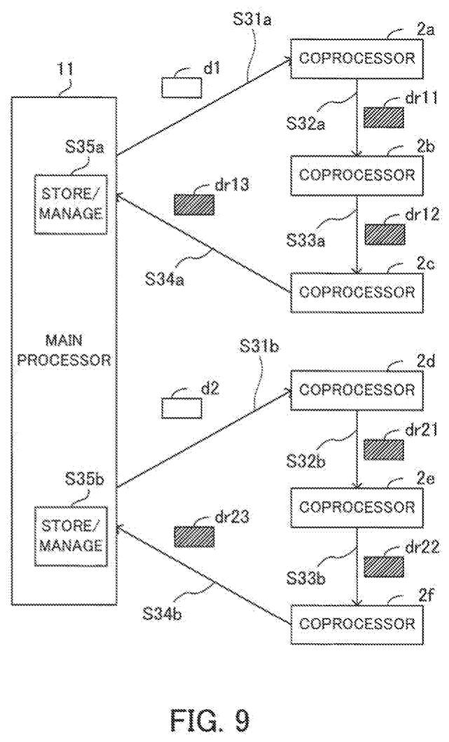

FIG. 9 depicts one example of distributed processing.

(Step S31a) The main processor 11 transmits data d1 to the coprocessor 2a.

(Step S32a) The coprocessor 2a receives the data d1, performs predetermined distributed processing, and transmits a processing result dr11 to the coprocessor 2b.

(Step S33a) The coprocessor 2b receives the processing result dr11, performs predetermined distributed processing, and transmits a processing result dr12 to the coprocessor 2c.

(Step S34a) The coprocessor 2c receives the processing result dr12, performs predetermined distributed processing, and transmits a processing result dr13 to the main processor 11.

(Step S35a) The main processor 11 stores and manages the processing result dr13.

(Step S31b) The main processor 11 transmits data d2 to the coprocessor 2d.

(Step S32b) The coprocessor 2d receives the data d2, performs predetermined distributed processing, and transmits a processing result dr21 to the coprocessor 2e.

(Step S33b) The coprocessor 2e receives the processing result dr21, performs predetermined distributed processing, and transmits a processing result dr22 to the coprocessor 2f.

(Step S34b) The coprocessor 2f receives the processing result dr22, performs predetermined distributed processing, and transmits a processing result dr23 to the main processor 11.

(Step S35b) The main processor 11 stores and manages the processing result dr23.

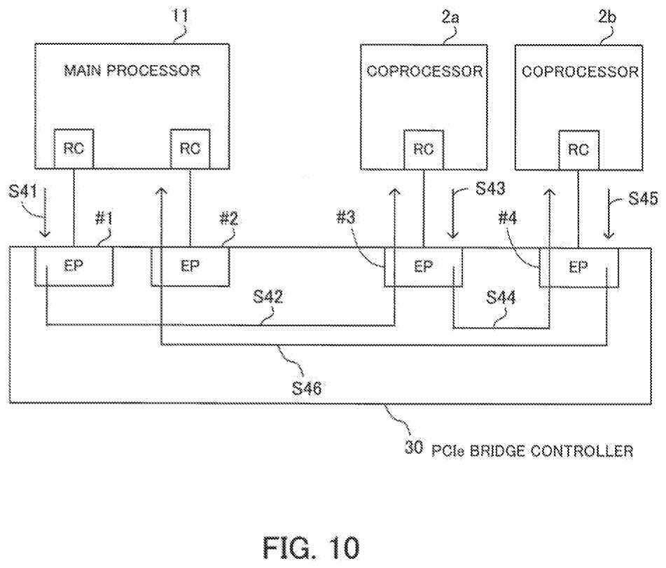

FIG. 10 depicts another example of distributed processing. FIG. 10 depicts a configuration of sequential distributed processing executed via a PCIe interface (and corresponds to a specific example of part of the configuration in FIG. 9).

The PCIe bridge controller 30 has EP #1, . . . , EP #4 (where EP #a indicates the EP of port a). The main processor 11 is connected to EP #1 and EP #2, the coprocessor 2a is connected to EP #3, and the coprocessor 2b is connected to EP #4.

(Step S41) The main processor 11 transmits data to EP #1.

(Step S42) The PCIe bridge controller 30 tunnels the data from EP #1 to EP #3, and transmits the data from EP #3 to the coprocessor 2a.

(Step S43) The coprocessor 2a executes distributed processing on the data to generate first result data, and transmits the first result data to EP #3.

(Step S44) The PCIe bridge controller 30 tunnels the first result data from EP #3 to EP #4 and transmits the first result data from EP #4 to the coprocessor 2b.

(Step S45) The coprocessor 2b executes distributed processing on the first result data to generate the second result data, and transmits the second result data to EP #4.

(Step S46) The PCIe bridge controller 30 tunnels the second result data from EP #4 to EP #2 and transmits the second result data from EP #2 to the main processor 11. Sequential distributed processing is executed by the processing flow from step S41 to step S46.

Note that the coprocessor 2a is capable of transmitting an intermediate processing result of the distributed processing to the main processor 11. In this particular example, the coprocessor 2a transmits the intermediate processing result to EP #3. The PCIe bridge controller 30 then tunnels the intermediate processing result from EP #3 to EP #2, and transmits the intermediate processing result from EP #2 to the main processor 11.

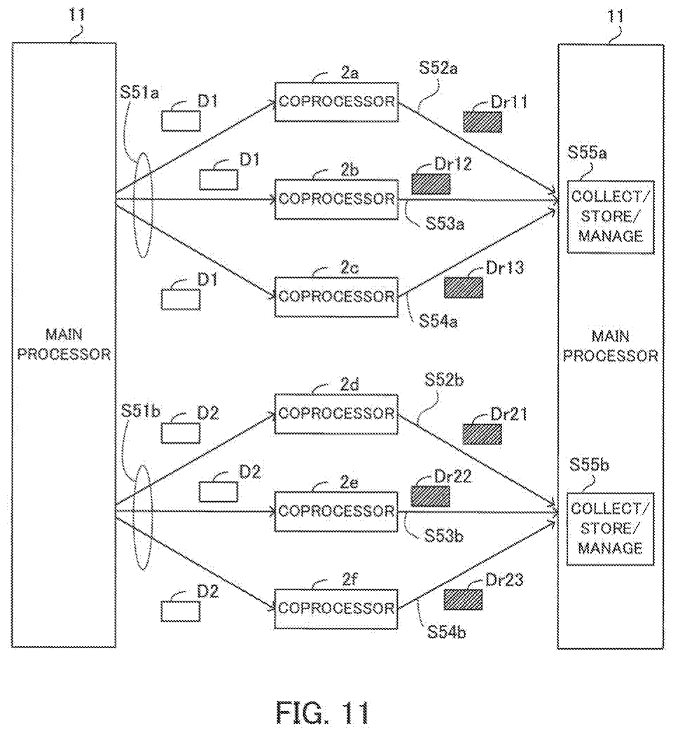

FIG. 11 depicts another example of distributed processing.

(Step S51a) The main processor 11 transmits data D1 to the coprocessors 2a, 2b, and 2c.

(Step S52a) The coprocessor 2a receives the data D1, executes predetermined distributed processing, and transmits a processing result Dr11 to the main processor 11.

(Step S53a) The coprocessor 2b receives the data D1, executes predetermined distributed processing, and transmits a processing result Dr12 to the main processor 11.

(Step S54a) The coprocessor 2c receives the data D1, executes predetermined distributed processing, and transmits a processing result Dr13 to the main processor 11.

(Step S55a) The main processor 11 collectively stores and manages the received processing results.

(Step S51b) The main processor 11 transmits data D2 to the coprocessors 2d, 2e, and 2f.

(Step S52b) The coprocessor 2d receives the data D2, executes predetermined distributed processing, and transmits a processing result Dr21 to the main processor 11.

(Step S53b) The coprocessor 2e receives the data D2, executes predetermined distributed processing, and transmits a processing result Dr22 to the main processor 11.

(Step S54b) The coprocessor 2f receives the data D2, executes predetermined distributed processing, and transmits a processing result Dr23 to the main processor 11.

(Step S55b) The main processor 11 collectively stores and manages the received processing results.

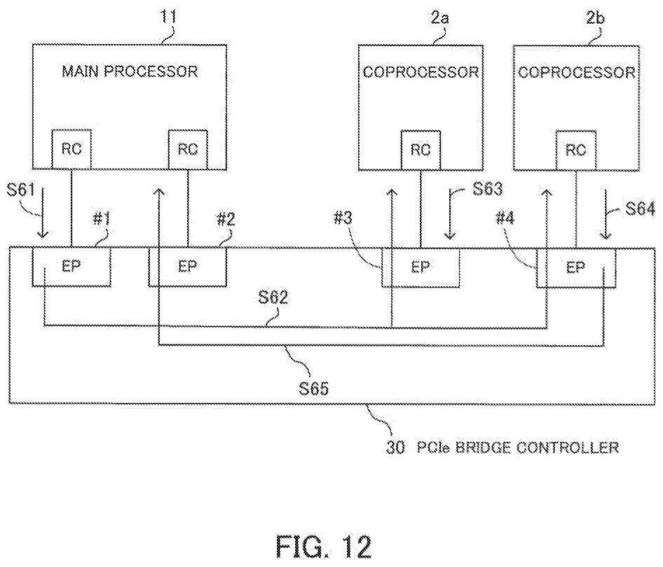

FIG. 12 depicts another example of distributed processing. FIG. 12 depicts a configuration for parallel distributed processing of the same data via a PCIe interface (and corresponds to a specific example of part of the configuration in FIG. 11).

The PCIe bridge controller 30 includes EP #1, . . . , EP #4. The main processor 11 is connected to EP #1 and EP #2, the coprocessor 2a is connected to EP #3, and the coprocessor 2b is connected to EP #4.

(Step S61) The main processor 11 transmits data to EP #1.

(Step S62) The PCIe bridge controller 30 tunnels the data from EP #1 to EP #3 and EP #4, transmits the data from EP #3 to the coprocessor 2a, and transmits the data from EP #4 to the coprocessor 2b.

(Step S63) The coprocessor 2a executes distributed processing on the data to generate first result data, and transmits the first result data to EP #3.

(Step S64) The coprocessor 2b executes distributed processing on the data to generate second result data, and transmits the second result data to EP #4.

(Step S65) The PCIe bridge controller 30 tunnels the first result data from EP #3 to EP #2, and tunnels the second result data from EP #4 to EP #2.

The first result data and second result data are then transmitted from EP #2 to the main processor 11. Parallel distributed processing of the same data is executed according to the processing flow from step S61 to step S65.

As described above, the configuration of the information processing system 1-2 enables devices to be driven independently and eliminate the need to develop drivers for individual devices. In the information processing system 1-2, the distributed processing is executed by performing data transfers between the coprocessors via the PCIe bridge controller 30 without passing through the main processor 11, and the execution result is then transmitted to the main processor 11. By doing so, it is possible to reduce the processing load of the main processor 11 and to suppress processing delays at the main processor 11 in keeping with this reduction in the processing load.

Definition File

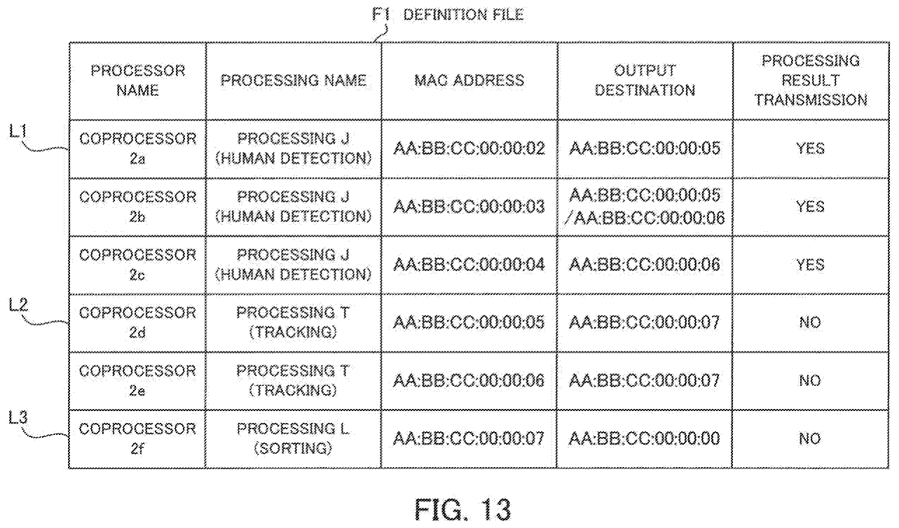

FIG. 13 depicts one example of a definition file. The host 10 stores the definition file F1 in the memory 15. The definition file F1 has columns of processor name, processing name, MAC (Media Access Control) address, output destination, and processing result transmission.

The processor name indicates the identifier of a coprocessor, the processing name indicates the content of the distributed processing assigned to that coprocessor, and the MAC address indicates the address of that coprocessor. The output destination indicates an output destination address for the distributed processing result of that coprocessor, and the processing result transmission indicates whether an intermediate processing result of the distributed processing is to be transmitted to the main processor 11. When the processing result transmission is “YES”, the intermediate processing result of that coprocessor is transmitted to the main processor 11, and when the processing result transmission is “NO”, the intermediate processing result of that coprocessor is not transmitted to the main processor 11.

As one example, the row L1 indicates that the MAC address of the coprocessor 2a is AA:BB:CC:00:00:02 and that processing J (human detection) is to be performed as the distributed processing. The row L1 also indicates that the result of the distributed processing is to be transmitted to the coprocessor 2d with the MAC address AA:BB:CC:00:00:05 and that the intermediate processing result is to be transmitted to the main processor 11.

The row L2 indicates that the MAC address of the coprocessor 2d is AA:BB:CC:00:00:05 and that processing T (tracking) is to be performed as the distributed processing. The row L2 also indicates that the result of the distributed processing is to be transmitted to the coprocessor 2f with the MAC address AA:BB:CC:00:00:07 and that the intermediate processing result is not to be transmitted to the main processor 11.

In addition, the row L3 indicates that the MAC address of the coprocessor 2f is AA:BB:CC:00:00:07 and that processing L (sorting) is to be performed as the distributed processing. The row L3 also indicates that the result of the distributed processing is to be transmitted to the main processor 11 with the MAC address AA:BB:CC:00:00:00 and that the intermediate processing result is not to be transmitted to the main processor 11.

Flowchart

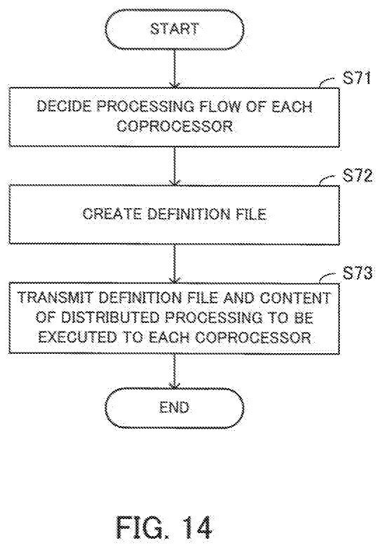

FIG. 14 is a flowchart depicting an example of a setting operation by the main processor.

[Step S71] The main processor 11 determines a processing flow for the coprocessors 2a, . . . , 2f.

[Step S72] The main processor 11 creates a definition file F1 based on the determined processing flow.

[Step S73] The main processor 11 transmits the definition file F1 and the content of the distributed processing to be executed to the coprocessors 2a, . . . , 2f.

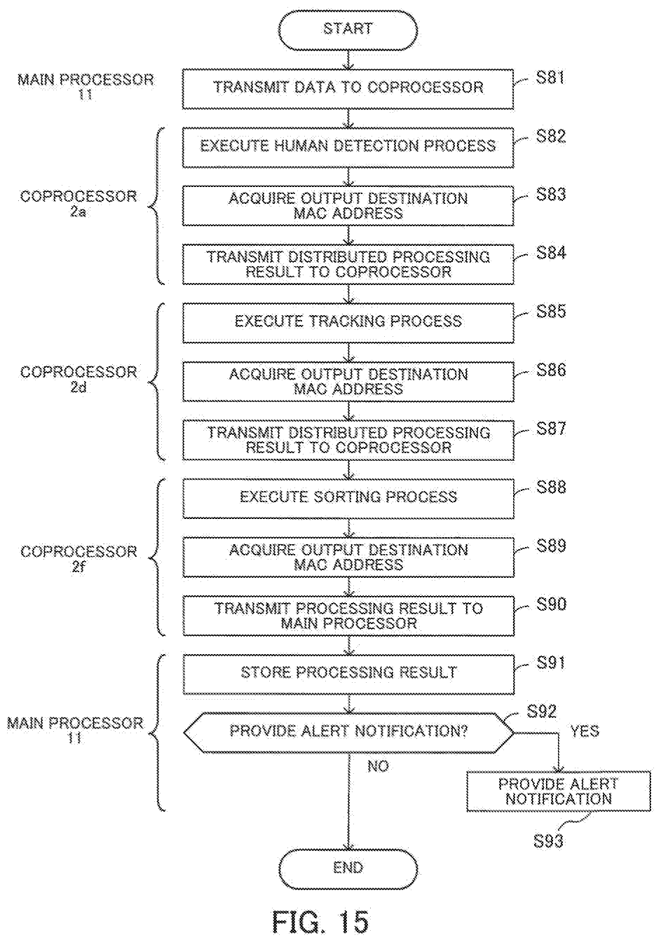

FIG. 15 is a flowchart depicting an example operation of distributed processing by the coprocessors. FIG. 15 depicts an example where image processing is performed as the distributed processing based on the definition file F1 depicted in FIG. 13.

(Step S81) The main processor 11 transmits data to the coprocessor 2a.

(Step S82) The coprocessor 2a executes a human detection process.

(Step S83) The coprocessor 2a acquires the MAC address of the output destination.

(Step S84) The coprocessor 2a transmits image information and detection information as the execution result of the human detection process via the PCIe bridge controller 30 to the coprocessor 2d.

(Step S85) The coprocessor 2d executes a tracking process.

(Step S86) The coprocessor 2d acquires the MAC address of the output destination.

(Step S87) The coprocessor 2d transmits image information and detection information as an execution result of the tracking process via the PCIe bridge controller 30 to the coprocessor 2f.

(Step S88) The coprocessor 2f executes a sorting process.

(Step S89) The coprocessor 2f acquires the MAC address of the output destination.

(Step S90) The coprocessor 2f transmits result information of the sorting process via the PCIe bridge controller 30 to the main processor 11.

(Step S91) The main processor 11 stores the result information of the sorting process.

(Step S92) The main processor 11 determines whether to provide an alert notification based on the result information of the sorting process. When it is determined to provide an alert notification, the processing proceeds to step S93, and when it is determined not to provide an alert notification, the processing ends.

[Step S93] The main processor 11 provides an alert notification.

The processing functions of the information processing systems 1-1 and 1-2 of the embodiments described above are realized by a computer. In this case, programs in which the processing contents of the functions to be provided in the information processing device 1, the computational processing device group 2 and the relay device 3, or the host 10, the devices 20-1, . . . , 20-6 and the PCIe bridge controller 30 are written are provided. By executing the programs on a computer, the processing functions described above are realized on a computer.

The programs in which the processing content is written may be recorded on a computer-readable recording medium. Examples of a computer-readable recording medium include magnetic storage devices, optical discs, magneto-optical recording media, and semiconductor memory. Magnetic storage devices include hard disk drives (HDD), flexible disks (FD), and magnetic tape. Optical discs include CD-ROM/RW and the like. Examples of magneto-optical recording media include an MO (Magneto-Optical) discs.

When a program is distributed, as one example, a portable recording medium, such as a CD-ROM, on which the program has been recorded may be sold. Alternatively, the program may be stored in a storage device of a server computer, and the program may be transferred from the server computer via a network to another computer.

As examples, the computer that executes a program stores the program, which was recorded on a portable recording medium or transferred from a server computer, in its own storage device. The computer then reads the program from its own storage device and executes processing according to the program. Note that the computer may also read the program directly from the portable recording medium and execute processing according to the program.

The computer may execute the processing according to a received program every time a program is transferred from the server computer connected via the network. Also, at least some of the processing functions described above may be realized by an electronic circuit such as a DSP, an ASIC, or a PLD.

Although PCIe has been described as an example of a bus (for example, an expansion bus) or an I/O interface for the various components in the embodiments described above, the bus or the I/O interface is not limited to PCIe. As one example, the bus or I/O interface for the various components may be any technology capable of transferring data between a device (a peripheral controller) and a processor using a data transfer bus. The data transfer bus may be a general-purpose bus that can transfer data at high speed in a local environment (for example, one system or one device) provided inside a single enclosure or the like. The I/O interface may be any of a parallel interface and a serial interface.

To perform serial transfer, the I/O interface may be configured to enable point-to-point connections and to transfer data on a packet basis. To perform serial transfer, the I/O interface may have a plurality of lanes. The layer structure of the I/O interface may include a transaction layer that generates and decodes packets, a data link layer that performs error detection and the like, and a physical layer that converts between serial and parallel. The I/O interface may include a root complex with one or a plurality of ports at the top of a hierarchy, an endpoint that is an I/O device, a switch for increasing the number of ports, a bridge for converting protocols, and the like. The I/O interface may multiplex the data to be transmitted and a clock signal using a multiplexer and transmit the multiplexed data. In this case, the receiver may separate the data and the clock signal using a demultiplexer.

According to the present embodiments, it is possible to transfer data with a reduced processing load at the host.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing system comprising:
a relay device that includes an expansion bus and relays communication via the expansion bus;
a computational processing device group that includes a plurality of computational processing devices individually connected to the expansion bus and performs distributed processing for computation on data inputted into any one of the plurality of computational processing devices through communication between the plurality of computational processing devices via the relay device; and
an information processing device that is connected to the expansion bus and acquires an execution result of the distributed processing from the computational processing device group via the relay device.

2. The information processing system according to claim 1,
wherein the relay device includes a plurality of end portions to which appliances are connected and cause the appliances to recognize the relay device as an end appliance of the expansion bus, and
the plurality of computational processing devices and the information processing device are connected on a one-to-one basis to the plurality of end portions, and each include a processor that recognizes the relay device as an end appliance of the expansion bus and controls communication via the expansion bus.

3. The information processing system according to claim 2,
wherein when the plurality of end portions of the relay device includes first, second, third, and fourth end portions, the information processing device is connected to the first and second end portions, a first computational processing device out of the computational processing device group is connected to the third end portion, and a second computational processing device out of the computational processing device group is connected to the fourth end portion,
the information processing device transmits the data to the first end portion,
the relay device tunnels the data from the first end portion to the third end portion and transmits the data from the third end portion to the first computational processing device,
the first computational processing device executes distributed processing on the data to generate first result data and transmits the first result data to the third end portion,
the relay device tunnels the first result data from the third end portion to the fourth end portion and transmits the first result data from the fourth end portion to the second computational processing device,
the second computational processing device executes distributed processing on the first result data to generate second result data and transmits the second result data to the fourth end portion, and
the relay device tunnels the second result data from the fourth end portion to the second end portion and transmits the second result data from the second end portion to the information processing device to execute sequential distributed processing.

4. The information processing system according to claim 3,
wherein the first computational processing device transmits a processing result of the distributed processing to the third end portion, and the relay device tunnels the processing result from the third end portion to the second end portion and transmits the processing result from the second end portion to the information processing device.

5. The information processing system according to claim 2,
wherein when the plurality of end portions of the relay device includes first, second, third, and fourth end portions, the information processing device is connected to the first and second end portions, a first computational processing device out of the computational processing device group is connected to the third end portion, and a second computational processing device out of the computational processing device group is connected to the fourth end portion,
the information processing device transmits the data to the first end portion,
the relay device tunnels the data from the first end portion to the third end portion and the fourth end portion, transmits the data from the third end portion to the first computational processing device, and transmits the data from the fourth end portion to the second computational processing device,
the first computational processing device executes distributed processing on the data to generate first result data and transmits the first result data to the third end portion,
the second computational processing device executes distributed processing on the data to generate second result data and transmits the second result data to the fourth end portion, and
the relay device tunnels the first result data from the third end portion to the second end portion, tunnels the second result data from the fourth end portion to the second end portion, and transmits the first result data and the second result data from the second end portion to the information processing device to execute parallel distributed processing on the same data.

6. The information processing system according to claim 1,
wherein the information processing device manages file information in which at least identifiers of the plurality of computational processing devices, a content of distributed processing to be executed by the plurality of computational processing devices, addresses of the plurality of computational processing devices, output destination addresses for results of the distributed processing, and an indication of whether a processing result of the distributed processing is to be transmitted to the information processing device are defined, and
the information processing device causes the computational processing device group to perform the distributed processing based on the file information.

7. The information processing system according to claim 1,
wherein the relay device has a function as an end point and relays communication between the plurality of computational processing devices.

8. A non-transitory computer-readable recording medium storing therein a computer program that causes a computer to execute a process comprising:
relaying, when the computer functions as a relay device, communication via an expansion bus;
performing, when the computer functions as a plurality of computational processing devices included in a computational processing device group connected to the expansion bus, distributed processing for computation on data inputted into any one of the plurality of computational processing devices through communication between the plurality of computational processing devices via the relay device; and
acquiring, when the computer functions as an information processing device connected to the expansion bus, an execution result of the distributed processing from the computational processing device group via the relay device.
